(19) United States
(12) Patent Application Publication
(10) Pub. No.: US 2026/0166729 A1
(43) Pub. Date: Jun. 18, 2026

(54) OPERATING METHOD AND OPERATION ASSISTANCE SYSTEM FOR ROBOT ARM

(71) Applicant: United Microelectronics Corp., Hsinchu (TW)

(72) Inventors: Shi-Hao WANG, Taichung City (TW); Chih-Chung KUO, Tainan City (TW); Wen-Yenn FAN, Taoyuan City (TW); Wei-Che LIN, Tainan City (TW); Chia-Jung CHANG, Tainan City (TW)

(21) Appl. No.: 18/983,862

(22) Filed: Dec. 17, 2024

(51) Int. Cl. B25J 9/16

(52) U.S. Cl. CPC B25J 9/1653

(57) ABSTRACT

An operating method and an operation assistance system for a robot arm are provided. The operating method for the robot arm includes the following steps. A plurality of moving detection values of the robot arm are obtained. At least one moving time length of at least one movement of the robot arm is obtained. A plurality of operation values are obtained. The filtering noises are filtered from the moving detection values via a clustering algorithm. A plurality of moving representative values of the moving detection values are obtained. A health status of the robot arm is obtained according to the moving representative values, the moving time length, and the operation values, via an NN algorithm.

### TECHNICAL FIELD

The disclosure relates in general to an operating method and an operation assistance system, and more particularly to an operating method and an operation assistance system for a robot arm.

### BACKGROUND

In the semiconductor manufacturing process, a robot arm could be used to transfer a wafer. If the robot arm tilts, the wafer may be damaged during transferring. The robot arm should be precisely controlled to prevent any damages.

### SUMMARY

The disclosure is directed to an operating method and an operation assistance system for a robot arm. The robot arm is monitored through AI technology and precisely controlled accordingly to prevent any damages.

According to one embodiment, an operating method for a robot arm. The operating method for the robot arm includes the following steps. A plurality of moving detection values of the robot arm are obtained. At least one moving time length of at least one movement of the robot arm is obtained. A plurality of operation values are obtained. The filtering noises are filtered from the moving detection values via a clustering algorithm. A plurality of moving representative values of the moving detection values are obtained. A health status of the robot arm is obtained according to the moving representative values, the moving time length, and the operation values, via an NN algorithm.

According to another embodiment, an operation assistance system for a robot arm is provided. The operation assistance system for the robot arm includes a moving detecting unit, a timer unit, a plurality of sensing units, a filtering unit, an averaging unit and a health analyzing unit. The moving detecting unit is configured to obtain a plurality of moving detection values of the robot arm. The timer unit is configured to obtain at least one moving time length of at least one movement of the robot arm. The sensing units are configured to obtain a plurality of operation values. The filtering unit is configured to filter noises from the moving detection values via a clustering algorithm. The averaging unit is configured to obtain a plurality of moving representative values of the moving detection values. The health analyzing unit is configured to obtain a health status of the robot arm according to the moving representative values, the moving time length, and the operation values, via an NN algorithm.

### BRIEF DESCRIPTION OF THE DRAWINGS

FIG. 1 shows an operation of a robot arm according to one embodiment of the present disclosure.

FIG. 2 shows a block diagram of an operation assistance system according to one embodiment of the present disclosure.

FIG. 3 shows a flowchart of an operating method of the robot arm according to one embodiment of the present disclosure.

FIG. 4 illustrates the step S110, S140 and S150 according to one embodiment of the present disclosure.

FIG. 5 shows a detail flowchart of the step S160 according to one embodiment of the present disclosure.

FIG. 6 illustrates an AutoEncoder algorithm according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

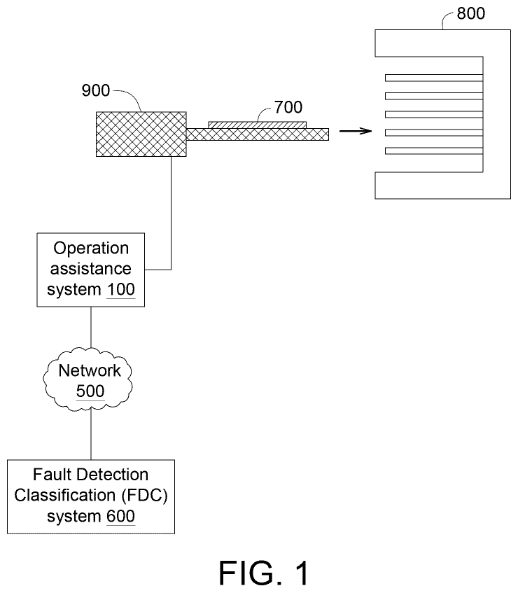

Please refer to FIG. 1, which shows an operation of a robot arm 900 according to one embodiment of the present disclosure. The robot arm 900 is, for example, used to transfer a wafer 700 among different locations. For example, as shown in the FIG. 1, the robot arm 100 transfers the wafer 700 into the cassette 800. The robot arm 100 should be controlled precisely to prevent any damages. In this embodiment, an operation assistance system 100 connected to the robot arm 900 is used to monitor the robot arm 900 and calibrate the robot arm 900. The data obtained by the operation assistance system 100 could be transmitted to a Classification (FDC) system 600 through the network 500.

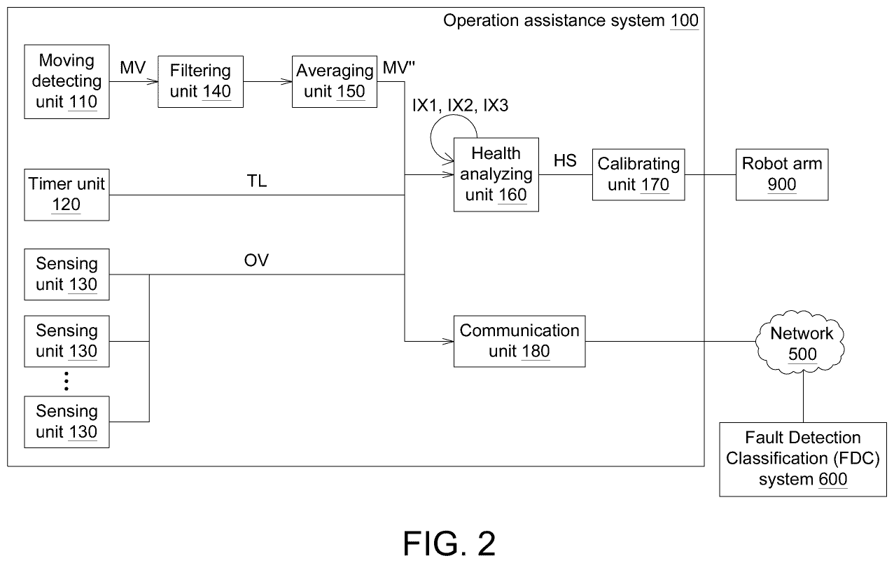

Please refer to FIG. 2, which shows a block diagram of the operation assistance system 100 according to one embodiment of the present disclosure. The operation assistance system 100 is, for example, a circuit board, a computer, a server or a control box. The operation assistance system 100 is connected to the robot arm 900 and located adjacent to the robot arm 900. The operation assistance system 100 includes a moving detecting unit 110, a timer unit 120, one or more sensing units 130, a filtering unit 140, an averaging unit 150, a health analyzing unit 160, a calibrating unit 170 and a communication unit 180. The moving detecting unit 110, the timer unit 120 and the sensing units 130 are used to detect the robot arm 900. The filtering unit 140, the averaging unit 150 and the health analyzing unit 160 are used to execute data processing procedures. The calibrating unit 170 is used to execute a calibrating procedure. The moving detecting unit 110, the timer unit 120, the sensing units 130, the filtering unit 140, the averaging unit 150, the health analyzing unit 160 and/or the calibrating unit 170 is, for example, a circuit, a circuit board, a storage device storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof. The communication unit 180 is used to transmit data. For example, the communication unit 180 is a wireless communication module or a wired communication module.

In the present embodiment, the robot arm 100 is monitored and precisely controlled to prevent any damages. The operation of those elements described above is described through a flowchart.

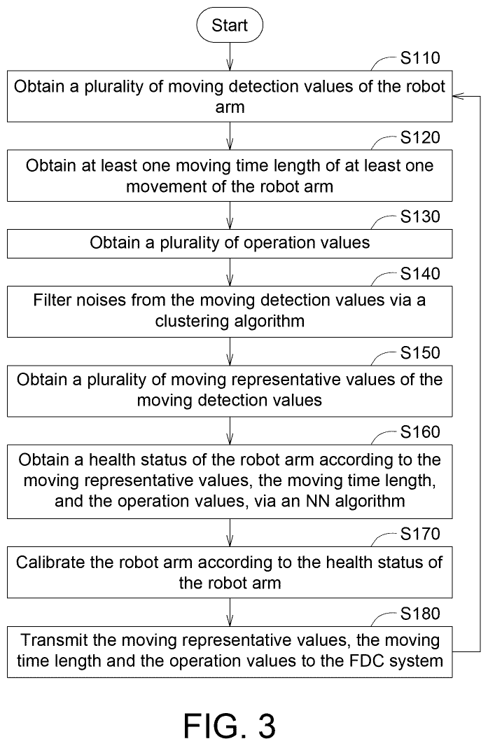

Please refer to FIG. 3, which shows a flowchart of an operating method of the robot arm 900 according to one embodiment of the present disclosure. The operating method of the robot arm 900 includes steps S110 to S180.

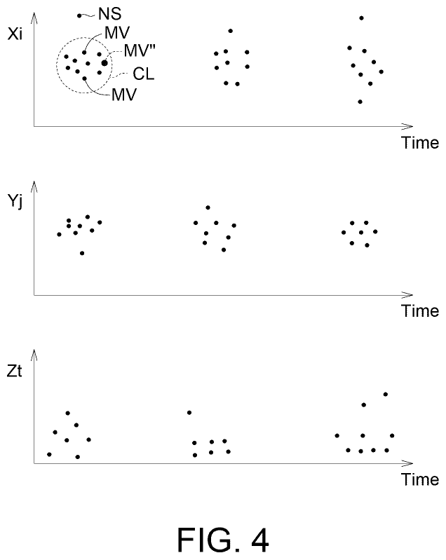

Please refer to FIG. 4, which illustrates the step S110, S140 and S150 according to one embodiment of the present disclosure. In the step S110, as shown in the FIG. 4, the moving detecting unit 110 obtains a plurality of moving detection values MV of the robot arm 900. The moving detection values MV include a plurality of X position values Xi, a plurality of Y position values Yj, and a plurality of Z position values Zt. The detecting unit 110 includes, for example, an X-direction laser sensor, a Y-direction laser sensor and a Z-direction sensor. The X laser sensor periodicity emits laser lights along an X direction to the wafer 700, and receives the reflected laser lights to obtain the X position values Xi. The Y laser sensor periodicity emits laser lights along a Y direction to the wafer 700, and receives the reflected laser lights to obtain the Y position values Yj. The Z laser sensor periodicity emits laser lights along a Z direction to the wafer 700, and receives the reflected laser lights to obtain the Z position values Zt. The X laser sensor, the Y laser sensor and the Z laser sensor may emit the laser lights synchronously or asynchronously. The X position values Xi, the Y position values Yj, and the Z position values Zt could be used to determine whether the operation of the robot arm 900 is normal.

Then, in the step S120, as shown in the FIG. 2, the timer unit 120 obtains at least one moving time length TL of at least one movement of the robot arm 900. For example, the at least one movement includes rotating the robot arm 900, moving forward the robot arm 900, moving backward the robot arm 900, raising the robot arm 900 and/or lowering the robot arm 900.

Next, in the step S130, as shown in the FIG. 2, the sensing units 130 obtain a plurality of operation values OV. For example, one of the sensing units 130 could be a vibration sensor used to detect a vibration value of the robot arm 900. One of the sensing units 130 could be a power detector used to detect a current value of a driving power of the robot arm 900. One of the sensing units 130 could be an inertial measurement unit (IMU) used to detect an acceleration value of the robot arm 900.

The step S110, the step S120 and the step S130 could be executed at the same time. Or, the step S110, the step S120 and the step S130 could be executed in a predetermined order.

Then, in the step S140, as shown in the FIG. 4, the filtering unit 140 filters noises NS from the moving detection values MV via a clustering algorithm, such as a DBSCAN algorithm. As shown in the FIG. 4, some of the X position values Xi are clustered into a cluster CL, the noise NS is not clustered into the cluster CL. This noise NS would be filtered out.

Afterwards, in the step S150, as shown in the FIG. 4, the averaging unit 150 obtains a plurality of moving representative values MV″ of the moving detection values MV. For example, the moving representative values MV″ is the average value of the moving detection values MV in the same cluster CL.

Next, in the step S160, as shown in the FIG. 2, the health analyzing unit 160 obtains a health status HS of the robot arm 900 according to the moving representative values MV″, the moving time length TL, and the operation values OV, via an NN algorithm, such as an AutoEncoder algorithm.

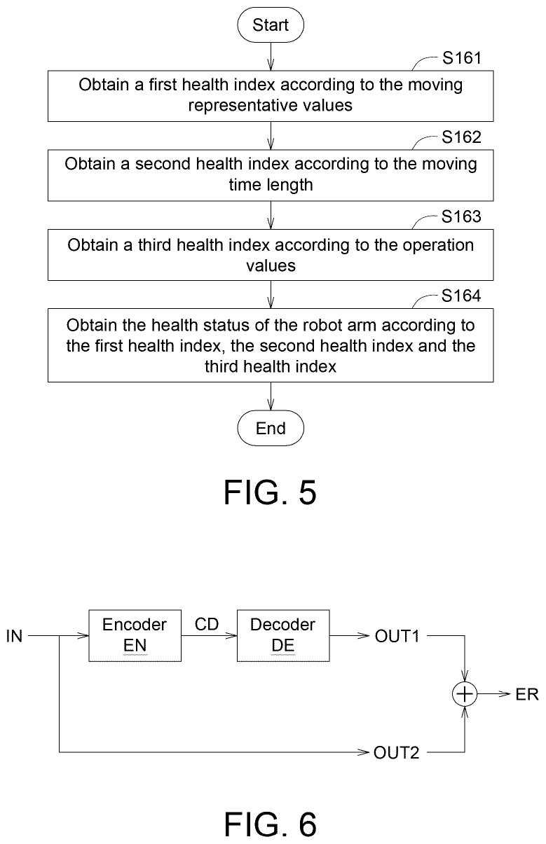

Please refer to FIG. 5, which shows a detail flowchart of the step S160 according to one embodiment of the present disclosure. The step S160 includes steps S161, S162, S162, S163 and S164.

In the step S161, as shown in the FIG. 2, the health analyzing unit 160 obtains a first health index IX1 according to the moving representative values MV″. Please refer to FIG. 6, which illustrates the AutoEncoder algorithm according to one embodiment of the present disclosure. In the AutoEncoder algorithm, an encoder EN is used to encode an input data IN to obtain a code CD, and then a decoder DE is used to decode the code CD to obtain an output data OUT1. On the other hand, an output data OUT2 which is identical to the input data IN is obtained. Afterwards, an error ER between the output data OUT1 and the output data OUT2 is obtained. The encoder EN and the decoder DE are trained through golden data. The health analyzing unit 160 could use the AutoEncoder algorithm to obtain the error ER. This error ER could be used to obtain the first health index IX1.

Then, in the step S162, as shown in the FIG. 2, the health analyzing unit 160 obtains a second health index IX2 according to the moving time length TL. The health analyzing unit 160 could use the AutoEncoder algorithm to obtain the error ER. This error ER could be used to obtain the second health index IX2.

Next, in the step S163, as shown in the FIG. 2, the health analyzing unit 160 obtains a third health index IX3 according to the operation values OV. The health analyzing unit 160 could use the AutoEncoder algorithm to obtain the error ER. This error ER could be used to obtain the third health index IX3.

Then, in the step S164, as shown in the FIG. 2, the health analyzing unit 160 obtains the health status HS of the robot arm 100 according to the first health index IX1, the second health index IX2 and the third health index IX3.

Afterwards, in the step S170, the calibrating unit 170 calibrates the robot arm 100 according to the health status HS of the robot arm 100. The health status HS could indicate a failure cause, such as that the Z-axis is offset, or the base is unstable.

Next, in the step S180, as shown in the FIG. 2, the transmitting unit 180 transmits the moving representative values MV″, the moving time length TL and the operation values OL to a Fault Detection Classification (FDC) system 600. The moving representative values MV″, the moving time length TL and the operation values OL could be recorded and used to predict the life of the robot arm 100.

According to the embodiments described above, the robot arm 100 is monitored through AI technology and precisely controlled accordingly to prevent any damages.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An operating method for a robot arm, comprising:
obtaining a plurality of moving detection values of the robot arm;
obtaining at least one moving time length of at least one movement of the robot arm;
obtaining a plurality of operation values;
filtering noises from the moving detection values via a clustering algorithm;
obtaining a plurality of moving representative values of the moving detection values; and
obtaining a health status of the robot arm according to the moving representative values, the moving time length, and the operation values, via an NN algorithm.

2. The operating method for the robot arm according to claim 1, wherein the moving detection values include a plurality of X position values, a plurality of Y position values, and a plurality of Z position values.

3. The operating method for the robot arm according to claim 1, wherein the operation values include a vibration value, a current value, or an acceleration value.

4. The operating method for the robot arm according to claim 1, wherein the clustering algorithm is a DBSCAN algorithm.

5. The operating method for the robot arm according to claim 1, wherein the NN algorithm is an AutoEncoder algorithm.

6. The operating method for the robot arm according to claim 1, wherein the step of obtaining the health status of the robot arm includes:
obtaining a first health index according to the moving representative values;
obtaining a second health index according to the moving time length;
obtaining a third health index according to the operation values; and
obtaining the health status of the robot arm according to the first health index, the second health index and the third health index.

7. The operating method of the robot arm according to claim 1, further comprising:
calibrating the robot arm according to the health status of the robot arm.

8. The operating method of the robot arm according to claim 1, wherein the health status indicates a failure cause.

9. The operating method of the robot arm according to claim 1, further comprising:
transmitting the moving representative values, the moving time length and the operation values to a Fault Detection Classification (FDC) system.

10. An operation assistance system for a robot arm, comprising:
a moving detecting unit, configured to obtain a plurality of moving detection values of the robot arm;
a timer unit, configured to obtain at least one moving time length of at least one movement of the robot arm;
a plurality of sensing units, configured to obtain a plurality of operation values;
a filtering unit, configured to filter noises from the moving detection values via a clustering algorithm;
an averaging unit, configured to obtain a plurality of moving representative values of the moving detection values;
and a health analyzing unit, configured to obtain a health status of the robot arm according to the moving representative values, the moving time length, and the operation values, via an NN algorithm.

11. The operation assistance system for the robot arm according to claim 10, wherein the moving detection values include a plurality of X position values, a plurality of Y position values, and a plurality of Z position values.

12. The operation assistance system for the robot arm according to claim 10, wherein the operation values include a vibration value, a current value, an acceleration value.

13. The operation assistance system for the robot arm according to claim 10, wherein the clustering algorithm is a DBSCAN algorithm.

14. The operation assistance system for the robot arm according to claim 10, wherein the NN algorithm is an AutoEncoder algorithm.

15. The operation assistance system for the robot arm according to claim 10, wherein the health analyzing unit obtains a first health index according to the moving representative values, obtains a second health index according to the moving time length, obtains a third health index according to the operation values, and obtains the health status of the robot arm according to the first health index, the second health index and the third health index.

16. The operation assistance system of the robot arm according to claim 10, further comprising:
a calibrating unit, configured to calibrate the robot arm according to the health status of the robot arm.

17. The operation assistance system of the robot arm according to claim 10, wherein the health status indicates a failure cause.

18. The operation assistance system of the robot arm according to claim 10, further comprising:
a communication unit, configured to transmit the moving representative values, the moving time length and the operation values to a Fault Detection Classification (FDC) system.
